(19) United States
(12) Patent Application Publication
(10) Pub. No.: US 2014/0062067 A1
(43) Pub. Date: Mar. 6, 2014

(54) AIRBAG COVER

(71) Applicant: TOYODA GOSEI CO., LTD., Aichi (JP)

(72) Inventors: Adam P. Hardin, Festus, MO (US); Peter L. Vigeant, Ste. Genevieve, MO (US); Lionel K. Cureau, Perryville, MO (US); Tood Huber, Perryville, MO (US)

(73) Assignee: TOYODA GOSEI CO., LTD., Aichi (JP)

(21) Appl. No.: 13/714,589

(22) Filed: Dec. 14, 2012

Related U.S. Application Data
(60) Provisional application No. 61/694,841, filed on Aug. 30, 2012.

(51) Int. Cl. B60R 21/2165

(52) U.S. Cl. CPC B60R 21/21656
USPC 280/728.3

(57) ABSTRACT

An example airbag cover includes an airbag cover having a front portion spaced from separation lines. The separation lines are configured to separate during expansion of an airbag. Another example airbag cover includes a front portion having an outwardly facing surface and an inwardly facing surface. A plurality of separation ribs extending away from the inwardly facing surface, the separation ribs include separation lines spaced from the inwardly facing surface. At least one hinge extends away from the inwardly facing surface.

### CROSS-REFERENCE TO RELATED APPLICATIONS

This application claims priority to U.S. Provisional Application No. 61/694841, which was filed on 30 Aug. 2012 and is incorporated herein by reference.

### BACKGROUND

Current airbag covers include a seam that encourages tearing and separation of the A-surface of the trim cover upon deployment of the airbag. The A-surface is the outer surface of the airbag cover that is visible to the driver. Such airbag cover designs may be undesirable. For example, the tear seam may cause witness marks and may pose aesthetic design limitations, including limiting the sizing and placement of the brand emblem that is commonly found on steering wheels.

### SUMMARY

An example airbag cover includes an airbag cover having a front portion spaced from separation lines. The separation lines are configured to separate during expansion of an airbag.

An example airbag cover includes a front portion having an outwardly facing surface and an inwardly facing surface. A plurality of separation ribs extending away from the inwardly facing surface, the separation ribs include separation lines spaced from the inwardly facing surface. At least one hinge extends away from the inwardly facing surface.

An example method of separating an airbag cover during an airbag deployment includes separating ribs extending from a surface of an airbag cover to permit airbag expansion.

### DESCRIPTION OF THE FIGURES

FIG. 1 shows a front view of an example seamless driver airbag cover.

FIG. 2 shows the reverse side of the schematic seamless driver airbag cover of FIG. 1.

FIG. 3 shows a perspective view of the schematic seamless driver airbag cover of FIG. 1.

FIG. 4 shows a cutaway view of the schematic seamless driver airbag cover of FIG. 1.

FIG. 5 shows one embodiment of the seamless driver airbag cover after airbag deployment.

FIG. 6 shows an alternate embodiment of the seamless driver airbag cover after airbag deployment.

### DETAILED DESCRIPTION

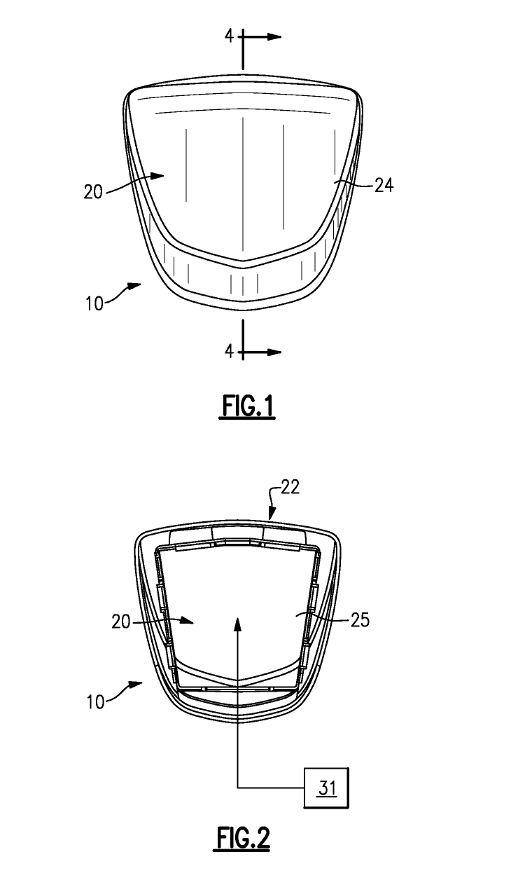

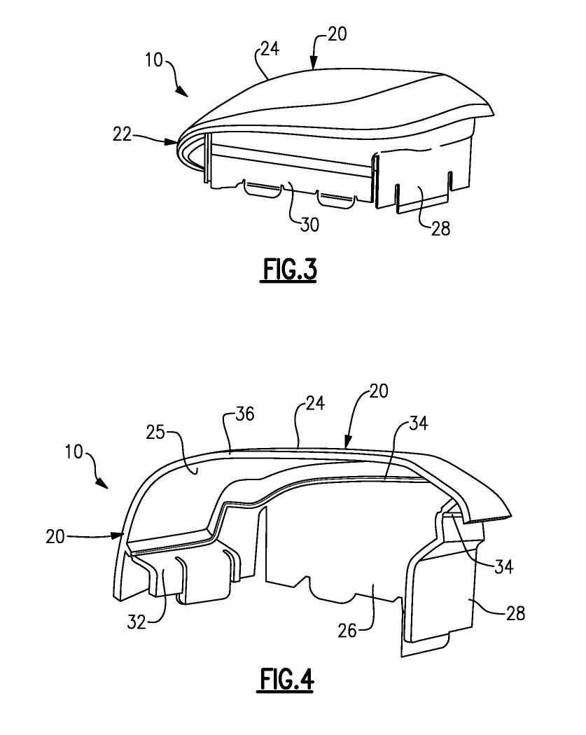

Referring to FIGS. 1 through 4, an example driver airbag cover 10 includes a front portion 20, which faces a driver, and an upper side 22 extending away from the driver. The cover 10 has an A-surface 24 and a B-surface 25. The A-surface 24 is visible to the driver. The B-surfaces faces in an opposite direction from the A-surface.

The driver airbag cover 10 includes walls that extend down from the B-surface 25. The walls include a first wall 26, a second wall 28, and a third wall 30. The cover 10 provides an opening that receives an airbag 31. Although described in this example as a cover for a driver airbag, the cover could be used in connection with other airbags, such as knee airbags.

The driver airbag cover 10 includes a hinge 32 on the upper side 22. The hinge 32 may be formed in the back plate of the driver airbag module.

The first, second, and third walls 26, 28, and 30 include a separation line 34 proximal to the front portion 20, but spaced away from the B-surface 25. The separation line 34 is thus spaced from the front portion 20. Because the separation lines 34 are located on the first, second, and third walls 26, 28, and 30 and spaced away from the B-surface 25, witness marks associated with the separation lines 34 are not visible when viewing the A-surface 24. The upper side 22 also includes separation line 36 on either side of the hinge 32. Witness marks associated with the separation line 36 are also not visible when viewing the A-surface 24.

When the airbag 31 is deployed, the driver airbag cover 10 begins to separate at approximately the center of the second wall 28 along the separation line 34. The driver airbag cover 10 continues to separate on the separation line 34 down the first wall 26 and the third walls 30 toward the hinge 32, and on the separation line 36 on either side of the hinge 32. Once the separation lines 34 and 36 are completely severed, the front portion 20 of the driver airbag cover 10 hinges upward on the hinge 32. The airbag 31 then freely expands unencumbered by the cover 10. The A-surface 24 and the front portion 20 remain in one-piece (completely intact) during the entire airbag deployment process.

The separation lines 34 and 36 can be formed in a number of ways. For example, the separation lines 34 and 36 can be formed by perforating the plastic along the desired separation path. In another example, the separation lines 34 and 36 can be portions of material that are thinner relative to the material of the rest of the driver airbag cover 10, such that the thinner material separates due to the force of airbag deployment, but the rest of the driver airbag cover 10 remains intact.

The hinge 32 can also be created in a number of ways. For example, the hinge 32 can be an area of thicker material relative to the material of the rest of the driver airbag cover 10 such that it the driver airbag cover 10 can separate along the separation lines 34 and 36 upon deployment of the airbag, but the hinge 32 remains intact.

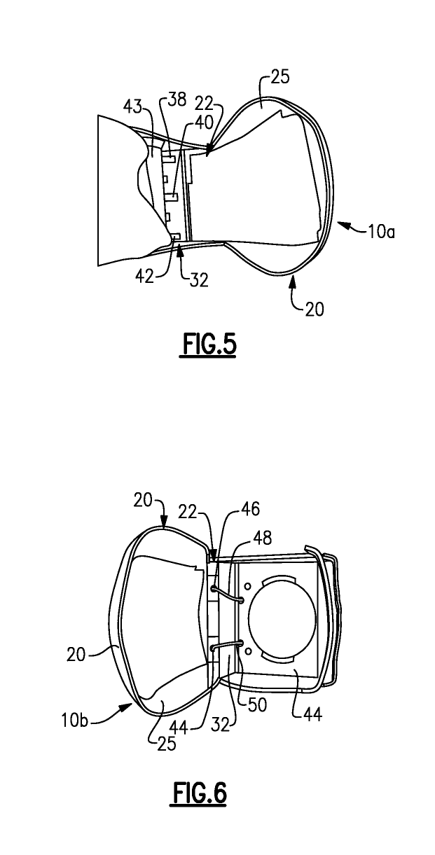

In another example, the hinge can have a binder-like design with rings that allow movement of the driver airbag cover 10. FIG. 5, for example, shows a driver airbag cover 10a after airbag deployment. In this embodiment, the driver airbag cover has fingers 38, 40 and 42 that are welded to a back plate 43 and made into a circle to form the hinge 32, similar to a binder. Holes are formed in the upper side 22 of the driver airbag cover that receives the fingers 38, 40, and 42 such that the driver airbag cover can hinge on the fingers 38, 40, and 42 when the airbag 31a is deployed.

FIG. 6 shows an alternate embodiment of the driver airbag cover 10b (after airbag deployment). This embodiment can be used for testing and simulation of the driver airbag cover hinging action. In this embodiment, the driver airbag cover has steel reinforced holes 44 and 46 on the upper side 22 of the driver airbag cover. Safety wires 48 and 50 pass through the holes 44 and 46, to connect the driver airbag cover to the back plate 43 of the driver airbag module while still allowing movement of the driver airbag cover so that it can open on the hinge 32. The steel reinforced holes 44 and 46 and the safety wires 48 and 50 are one example way of forming the hinge 32. Other techniques for forming the hinge 32 are possible.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. An airbag cover comprising:
an airbag cover having a front portion spaced from separation lines, the separation lines configured to separate during expansion of an airbag.

2. The airbag cover of claim 1, wherein the airbag cover is a driver airbag cover.

3. The airbag cover of claim 1, wherein the separation lines are configured to separate to permit the front portion to move together during expansion of the airbag while the front portion is completely intact.

4. The airbag cover of claim 1, including a plurality of walls extending from a surface of the airbag cover, the separation lines bounded by portions of the plurality of walls and spaced from the surface.

5. The airbag cover of claim 4, wherein the front portion includes an A-surface extending laterally past the plurality of walls.

6. The airbag cover of claim 4, wherein the plurality of walls are spaced inward from a laterally outermost edge of the front portion.

7. The airbag cover of claim 4, wherein the plurality of walls are configured to engage a steering wheel.

8. The airbag cover of claim 4, wherein the surface is a B-surface of the airbag cover.

9. The airbag cover of claim 1, wherein the airbag cover includes a hinge configured to the front portion of the airbag cover to another portion of the airbag cover both when the separation lines are joined and when the separation lines are separated.

10. The airbag cover of claim 1, wherein the separation lines are areas of the plurality of walls that are thinner than other areas of the plurality of walls.

11. An airbag cover, comprising:
a front portion having an outwardly facing surface and an inwardly facing surface;
a plurality of separation ribs extending away from the inwardly facing surface, the separation ribs include separation lines spaced from the inwardly facing surface; and
at least one hinge extending away from the inwardly facing surface.

12. The airbag cover of claim 11, wherein two of the plurality of separation ribs extend generally downward from positions adjacent opposing ends of the at least one hinge.

13. The airbag cover of claim 11, wherein the plurality of separation ribs are configured to separate at the separation lines during a deployment of an airbag.

14. The airbag cover of claim 11, wherein the front portion is configured to remain intact before a deployment of an airbag and after deployment of the airbag.

15. A method of separating an airbag cover during an airbag deployment, comprising:
separating ribs extending from a surface of an airbag cover to permit airbag expansion.

16. The method of claim 15, wherein the airbag expands between at least two separating ribs.

17. The method of claim 15, wherein the ribs separate at separation lines on the ribs, the separation lines spaced from the surface.

18. The method of claim 17, including perforating the ribs to provide the separation lines.
